(19) United States
(12) Patent Application Publication
(10) Pub. No.: US 2021/0118381 A1
(43) Pub. Date: Apr. 22, 2021

(54) DISPLAY DEVICE, AND DRIVING METHOD FOR DISPLAY PANEL

(71) Applicants: Chongqing HKC Optoelectronics Technology Co., Ltd., Chongqing (CN); HKC Corporation Limited, Guangdong (CN)

(72) Inventors: Wenqin Zhao, Chongqing (CN); Wei Chen, Chongqing (CN)

(73) Assignees: Chongqing HKC Optoelectronics Technology Co., Ltd., Chongqing (CN); HKC Corporation Limited, Guangdong (CN)

(21) Appl. No.: 17/041,369

(22) PCT Filed: Mar. 29, 2019
(86) PCT No.: PCT/CN2019/080309

§ 371 Date: Sep. 24, 2020

(30) Foreign Application Priority Data
Sep. 28, 2018 (CN) 201811137831.8
Feb. 2, 2019 (CN) 201910107530.9

(51) Int. Cl. G09G 3/36

(52) U.S. Cl. CPC G09G 3/3614; G09G 2320/0242; G09G 3/3607

(57) ABSTRACT

A display device and a driving method of a display panel are disclosed. The method includes driving a first pixel unit by a first voltage signal, and driving a second pixel unit by a second voltage signal. The first pixel unit and the second pixel unit are adjacent pixel units.

### CROSS REFERENCE TO RELATED APPLICATIONS

This application claims priority of Chinese patent application No. 2018111378318, entitled “DISPLAY DEVICE, AND DRIVING METHOD FOR DISPLAY PANEL” filed on Sep. 28, 2018, and the content of which is incorporated herein by reference in its entirety.

This application further claims priority of Chinese patent application No. 2019101075309, entitled “DISPLAY DEVICE, AND DRIVING METHOD FOR DISPLAY PANEL” filed on Feb. 2, 2019, and the content of which is incorporated herein by reference in its entirety.

### TECHNICAL FIELD

The present application relates to a display device and a driving method of a display panel.

### BACKGROUND

With the development of liquid crystal display technology, users are increasingly demanding a display image quality. Among the indicators that measure the display image quality, a chroma viewing angle is a crucial indicator. There is a normal viewing angle range in the liquid crystal display panel, and the liquid crystal display panel can provide a normal display image quality within a normal viewing angle range. However, the normal viewing angle range of the liquid crystal display panel is relatively small, and when the liquid crystal display panel is beyond the normal viewing angle range, that is, when at a large viewing angle, the liquid display panel has a defect of displaying color shift. To solve the defect of displaying color shift at a large viewing angle, generally, in the liquid crystal display panel, the pixels are divided into two parts for driving, and the color shift at large viewing angle is improved by mixing the two parts of the pixels. However, the inventors have realized that dividing the pixel into two parts reduces the transmittance of the liquid crystal display panel.

### SUMMARY

According to various embodiments of the present application, a display device and a driving method of a display panel is provided.

A display device is provided, including a display panel and a driving module;

the display panel includes pixel units arranged in an array;

the driving module is configured to: drive the first pixel unit by the first voltage signal, and drive the second pixel unit by the second voltage signal;

the first pixel unit and the second pixel unit are adjacent pixel units;

an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit.

In one of the embodiments, the driving module is further configured to:

drive a third pixel unit by a third voltage signal, and drive a fourth pixel unit by a fourth voltage signal; the first pixel unit, the second pixel unit, the third pixel unit, and the fourth pixel unit are pixel units arranged in sequence;

the third voltage signal is opposite in polarity to the first voltage signal;

the fourth voltage signal is opposite in polarity to the second voltage signal.

In one of the embodiments, the pixel unit includes a plurality of sub-pixels;

the first voltage signal includes a plurality of first sub-voltage signals; the second voltage signal includes a plurality of second sub-voltage signals; the third voltage signal includes a plurality of third sub-voltage signals; the fourth voltage signal includes a plurality of fourth sub-voltage signals;

each of the first sub-voltage signals drives each of the sub-pixels of the first pixel unit respectively; each of the second sub-voltage signals drives each of the sub-pixels of the second pixel unit respectively; each of the second sub-voltage signals drives each of the sub-pixels of the second pixel unit respectively; each of the second sub-voltage signals drives each of the sub-pixels of the second pixel unit respectively;

the first sub-voltage signal driving the corresponding sub-pixel is opposite in polarity to the third sub-voltage signal; the second sub-voltage signal driving the corresponding sub-pixel is opposite in polarity to the fourth sub-voltage signal.

In one of the embodiments, the driving module is further configured to:

perform a positive polarity drive to the first sub-pixel, and perform a negative polarity drive to the second sub-pixel; the first sub-pixel and the second sub-pixel are adjacent sub-pixels.

In one of the embodiments, the pixel units arranged in sequence include pixel units arranged in sequence in a row direction and pixel units arranged in sequence in a column direction.

In one of the embodiments, the pixel units arranged in sequence include pixel units arranged in sequence in a row direction and pixel units arranged in sequence in a column direction.

In one of the embodiments, the adjacent pixel units include adjacent pixel units in a row direction.

In one of the embodiments, the adjacent pixel units include adjacent pixel units in a column direction.

In one of the embodiments, performing a positive polarity drive to the first sub-pixel is to drive the first sub-pixel by a sub-voltage signal that is higher than a common voltage.

In one of the embodiments, performing a negative polarity drive to the second sub-pixel is to drive the second sub-pixel by a sub-voltage signal that is lower than a common voltage.

A driving method of a display panel, the display panel includes pixel units arranged in an array, and columns formed by the arrangement of the pixel units are arranged in a sequence in a row direction, and the driving method includes the steps of:

driving a first pixel unit by a first voltage signal, and driving a second pixel unit by a second voltage signal;

the first pixel unit and the second pixel unit are adjacent pixel units;

an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit.

In one of the embodiments, the driving method further includes the steps of:

driving a third pixel unit by a third voltage signal, and driving a fourth pixel unit by a fourth voltage signal; the first pixel unit, the second pixel unit, the third pixel unit, and the fourth pixel unit are pixel units arranged in sequence;

the third voltage signal is opposite in polarity to the first voltage signal;

the fourth voltage signal is opposite in polarity to the second voltage signal.

In one embodiment, the pixel unit includes a plurality of sub-pixels. The first voltage signal includes a plurality of first sub-voltage signals; the second voltage signal includes a plurality of second sub-voltage signals; the third voltage signal includes a plurality of third sub-voltage signals; the fourth voltage signal includes a plurality of fourth sub-voltage signals;

each of the first sub-voltage signals drives each of the sub-pixels of the first pixel unit respectively; each of the second sub-voltage signals drives each of the sub-pixels of the second pixel unit respectively; each of the second sub-voltage signals drives each of the sub-pixels of the second pixel unit respectively; each of the second sub-voltage signals drives each of the sub-pixels of the second pixel unit respectively;

the first sub-voltage signal driving the corresponding sub-pixel is opposite in polarity to the third sub-voltage signal; the second sub-voltage signal driving the corresponding sub-pixel is opposite in polarity to the fourth sub-voltage signal.

In one of the embodiments, the method further includes the steps of:

performing a positive polarity drive to the first sub-pixel, and performing a negative polarity drive to the second sub-pixel; the first sub-pixel and the second sub-pixel are adjacent sub-pixels.

In one of the embodiments, the pixel units arranged in sequence include pixel units arranged in sequence in a row direction and pixel units arranged in sequence in a column direction.

In one of the embodiments, the pixel units arranged in sequence include pixel units arranged in sequence in a row direction and pixel units arranged in sequence in a column direction.

In one of the embodiments, the adjacent pixel units include adjacent pixel units in a row direction.

In one of the embodiments, the adjacent pixel units include adjacent units in a column direction.

In one of the embodiments, performing a positive polarity drive to the first sub-pixel is to drive the first sub-pixel by a sub-voltage signal that is higher than a common voltage.

In one of the embodiments, performing a negative polarity drive to the second sub-pixel is to drive the second sub-pixel by a sub-voltage signal that is lower than a common voltage.

A display module is provided, including a backlight board and a display device;

the display device includes a display panel and a driving module;

the display panel includes pixel units arranged in array;

the driving module is configured to: drive a first pixel unit by a first voltage signal, and drive a second pixel unit by a second voltage signal;

the first pixel unit and the second pixel unit are adjacent pixel units;

an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit;

the backlight board is configured to provide a light source for the display panel.

The details of one or more embodiments of the application are set forth in the accompanying drawings and the description below. Other features, objects, and advantages of the application will be apparent from the description and drawings, and from the claims.

### BRIEF DESCRIPTION OF THE DRAWINGS

To illustrate the technical solutions according to the embodiments of the present application or in the prior art more clearly, the accompanying drawings for describing the embodiments or the prior art are introduced briefly in the following. Apparently, the accompanying drawings in the following description are only some embodiments of the present application, and persons of ordinary skill in the art can derive other drawings from the accompanying drawings without creative efforts.

FIG. 1 is a schematic structural diagram of a display panel according to one or more embodiments.

FIG. 2 is a flow diagram of a driving method of a display panel according to one or more embodiments.

FIG. 3 is a schematic diagram of driving a display panel according to one or more embodiments.

FIG. 4 is a flow diagram of a driving method of a display panel according to another embodiment.

FIG. 5 is a schematic diagram of a sub-pixel driving voltage signal according to one or more embodiments.

FIG. 6 is a flow diagram of a driving method of a display panel according to a further embodiment.

FIG. 7 is a schematic structural diagram of a display device according to one or more embodiments.

### DETAILED DESCRIPTION OF THE EMBODIMENTS

In order to make the technical solutions and advantages of the present application more clear, the present application will be further described in detail below with reference to the accompanying drawings and embodiments. It should be understood that the specific embodiments described herein are merely illustrative of the application and are not intended to be limiting.

According to the embodiment of the present invention, a driving method of a display panel is provided.

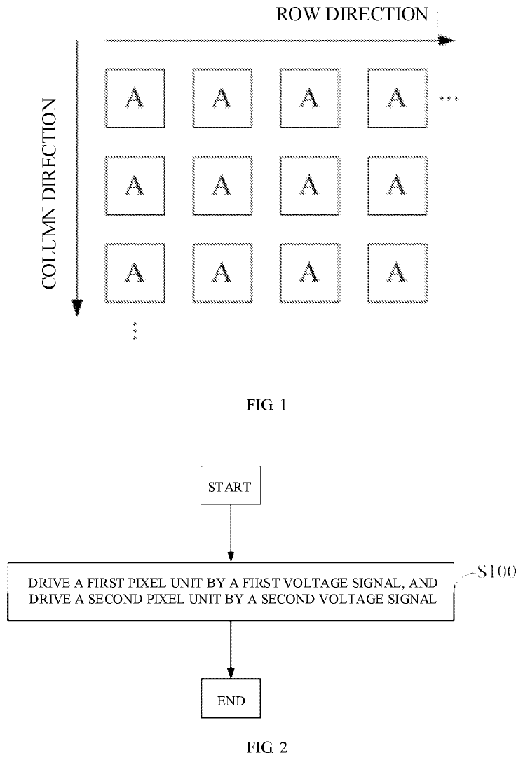

FIG. 1 is a schematic structural diagram of a display panel according to one or more embodiments. As shown in FIG. 1, the display panel includes pixel units A arranged in an array, and columns formed by the arrangement of the pixel units are arranged in a sequence in a row direction.

FIG. 2 is a flow diagram of a driving method of a display panel according to one or more embodiments. As shown in FIG. 2, the driving method of the display panel includes step S100:

S100, driving a first pixel unit by a first voltage signal, and driving a second pixel unit by a second voltage signal.

In one of the embodiments, the first pixel unit and the second pixel unit are adjacent pixel units;

In one of the embodiments, as shown in FIG. 1, adjacent pixel units include adjacent pixel units in the row direction and adjacent units in a column direction.

An absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; in one of the embodiments, the preset voltage is the voltage required for normal display of each pixel unit.

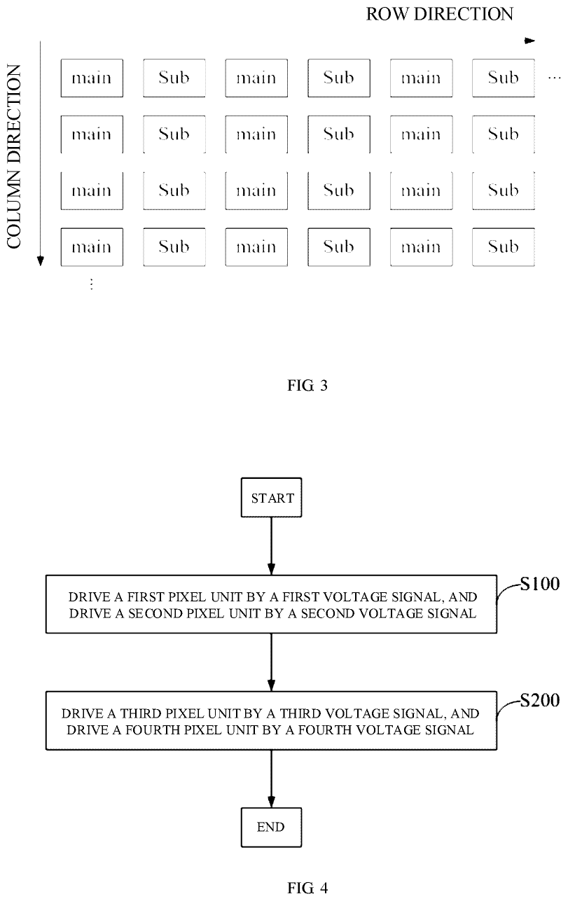

The absolute value of the first voltage signal being greater than that of a preset voltage, and an absolute value of the second voltage signal being less than that of the preset voltage is taken as an example. Let the absolute value of the first voltage signal be V1, the absolute value of the second voltage signal be V2, and the preset voltage be Va, that is, V1>Va>V2. In one of the embodiments, the larger the voltage signal driving the pixel unit is, the greater the display brightness of the driven pixel unit. FIG. 3 is a schematic diagram of driving a display panel according to one or more embodiment. As shown in FIG. 3, the pixel unit driven by the first voltage signal V1 is main, and the pixel unit driven by the second voltage signal V2 is sub. Also shown in FIG. 3, the main pixel unit and the sub pixel unit are arranged alternately in the row direction or the column direction, so as to realize a mixture of the main pixel unit and the sub pixel unit.

In one of the embodiments, FIG. 4 is a flow diagram of a driving method of a display panel according to another embodiment. As shown in FIG. 4, the driving method of the display panel further includes step S200:

S200, driving a third pixel unit by a third voltage signal, and driving a fourth pixel unit by a fourth voltage signal. In one of the embodiments, the first pixel unit, the second pixel unit, the third pixel unit, and the fourth pixel unit are pixel units arranged in sequence.

In one of the embodiments, as shown in FIG. 1, the pixel units arranged in sequence include pixel units arranged in sequence in the row direction and pixel units A arranged in sequence in the column direction.

The third voltage signal is opposite in polarity to the first voltage signal.

The fourth voltage signal is opposite in polarity to the second voltage signal.

In one of the embodiments, the polarity of the voltage signal is based on the common voltage Vcom of the display panel. The voltage signal greater than the common voltage Vcom is a positive polarity voltage, and the voltage signal less than the common voltage Vcom is a negative polarity voltage. The third voltage signal is opposite in polarity to the first voltage signal, including the first voltage signal being greater than the common voltage Vcom and the third voltage signal being less than the common voltage Vcom, or the first voltage signal being less than the common voltage Vcom, and the third voltage signal being greater than the common voltage Vcom. Similarly, the fourth voltage signal is opposite in polarity to the second voltage signal, including the fourth voltage signal being greater than the common voltage Vcom and the second voltage signal being less than the common voltage Vcom, or the fourth voltage signal being less than the common voltage Vcom, the second voltage signal being greater than the common voltage Vcom.

In one of the embodiments, the pixel unit includes a plurality of sub-pixels. The first voltage signal includes a plurality of first sub-voltage signals. The second voltage signal includes a plurality of second sub-voltage signals. The third voltage signal includes a plurality of third sub-voltage signals. The fourth voltage signal includes a plurality of fourth sub-voltage signals.

Each of the first sub-voltage signals drives each of the sub-pixels of the first pixel unit respectively; each of the second sub-voltage signals drives each of the sub-pixels of the second pixel unit respectively; each of the second sub-voltage signals drives each of the sub-pixels of the second pixel unit respectively; each of the second sub-voltage signals drives each of the sub-pixels of the second pixel unit respectively.

The first sub-voltage signal driving the corresponding sub-pixel is opposite in polarity to the third sub-voltage signal; the second sub-voltage signal driving the corresponding sub-pixel is opposite in polarity to the fourth sub-voltage signal.

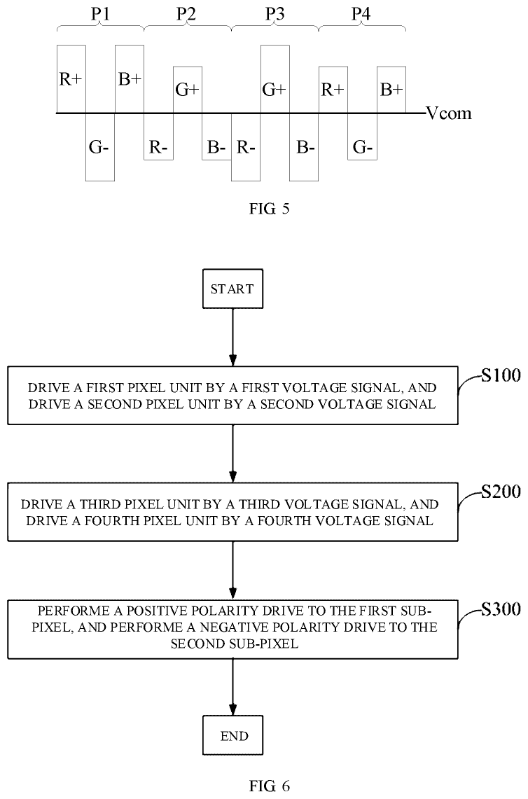

In one of the embodiments, FIG. 5 is a schematic diagram of a sub-pixel driving voltage signal according to one or more embodiments. As shown in FIG. 5, four pixel units P1, P2, P3, and P4 being arranged in sequence in the row direction and each pixel unit including three sub-pixels R, G, and B are explained as examples. In one of the embodiments, the pixel unit P1 corresponds to the first pixel unit, the pixel unit P2 corresponds to the second pixel unit, the pixel unit P3 corresponds to the third pixel unit, and the pixel unit P4 corresponds to the fourth pixel unit. As shown in FIG. 5, the first sub-voltage signal of the sub-pixel R in the first pixel unit P1 is R+, and the third sub-voltage signal of the sub-pixel R in the third pixel unit P3 is R-. In one of the embodiments, “+” represents that the voltage signal is greater than the common voltage Vcom, and “−” indicates that the voltage signal is less than the common voltage Vcom. As seen from FIG. 5, the absolute values of the sub-voltage signals of the corresponding sub-pixels in the first pixel unit P1 and the third pixel unit P3 are the same, but the polarities are opposite.

In one of the embodiments, FIG. 6 is a flow diagram of a driving method of a display panel according to a further embodiment. As shown in FIG. 6, the driving method of the display panel further includes step S300:

S300, performing a positive polarity drive to the first sub-pixel, and performing a negative polarity drive to the second sub-pixel. In one of the embodiments, the first sub-pixel and the second sub-pixel are adjacent sub-pixels.

In one of the embodiments, performing a positive polarity drive to the first sub-pixel means that the first sub-pixel is driven by a sub-voltage signal higher than the common voltage

Vcom. Similarly, performing a negative polarity drive to the second sub-pixel means that the second sub-pixel is driven by a sub-voltage signal lower than the common voltage Vcom. In one of the embodiments, the adjacent sub-pixels include adjacent sub-pixels in the row direction and adjacent sub-pixels in the column direction.

According to the driving method of the display panel described above, the first pixel unit is driven by the first voltage signal, and the second pixel unit is driven by the second voltage signal. In one of the embodiments, the first pixel unit and the second pixel unit are adjacent pixel units. In addition, the absolute value of the first voltage signal is greater than that of a preset voltage, and the absolute value of the second voltage signal is less than that of the preset voltage; or the absolute value of the first voltage signal is less than that of a preset voltage, and the absolute value of the second voltage signal is greater than that of the preset voltage. In one of the embodiments, the preset voltage is the voltage required for normal display of each pixel unit. Based on the above, the adjacent pixel units are respectively driven by voltage signals of different values. In this way the display of adjacent pixel units is mixed, so as to improve the chroma viewing angle of the display panel.

According to the embodiment of the present invention, a display device is further provided.

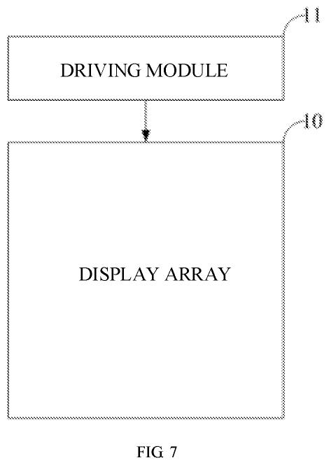

FIG. 7 is a schematic structural diagram of a display device according to one or more embodiments. As shown in FIG. 7, the display device includes a display panel 10 and a driving module 11.

The display panel 10 includes pixel units arranged in an array.

The driving module 11 is configured to:

drive a first pixel unit by a first voltage signal, and drive a second pixel unit by a second voltage signal.

In one of the embodiments, the first pixel unit and the second pixel unit are adjacent pixel units.

An absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; in one of the embodiments, the preset voltage is the voltage required for normal display of each pixel unit.

In one of the embodiments, the driving module 11 is further and specifically configured to:

drive a third pixel unit by a third voltage signal, and drive a fourth pixel unit by a fourth voltage signal. In one of the embodiments, the first pixel unit, the second pixel unit, the third pixel unit, and the fourth pixel unit are pixel units arranged in sequence.

The third voltage signal is opposite in polarity to the first voltage signal.

The fourth voltage signal is opposite in polarity to the second voltage signal.

In one of the embodiments, the pixel unit includes a plurality of sub-pixels;

The first voltage signal includes a plurality of first sub-voltage signals; the second voltage signal includes a plurality of second sub-voltage signals; the third voltage signal includes a plurality of third sub-voltage signals; the fourth voltage signal includes a plurality of fourth sub-voltage signals.

Each of the first sub-voltage signals drives each of the sub-pixels of the first pixel unit respectively; each of the second sub-voltage signals drives each of the sub-pixels of the second pixel unit respectively; each of the second sub-voltage signals drives each of the sub-pixels of the second pixel unit respectively; each of the second sub-voltage signals drives each of the sub-pixels of the second pixel unit respectively.

The first sub-voltage signal driving the corresponding sub-pixel is opposite in polarity to the third sub-voltage signal; the second sub-voltage signal driving the corresponding sub-pixel is opposite in polarity to the fourth sub-voltage signal.

In one of the embodiments, each of the first sub-voltage signals has a same absolute value being equal to the absolute value of the first voltage signal; each of the second sub-voltage signals has a same absolute value being equal to the absolute value of the second voltage signal; each of the third sub-voltage signals has a same absolute value being equal to the absolute value of the third voltage signal; and each of the fourth sub-voltage signals has a same absolute value being equal to the absolute value of the fourth voltage signal.

In one embodiment, the driving module 11 is further configured to:

perform a positive polarity drive to the first sub-pixel, and perform a negative polarity drive to the second sub-pixel. In one of the embodiments, the first sub-pixel and the second sub-pixel are adjacent sub-pixels.

In one of the embodiments, the pixel units arranged in sequence include pixel units arranged in sequence in a row direction and pixel units arranged in sequence in a column direction.

According to the above display device, the first pixel unit is driven by the first voltage signal, and the second pixel unit is driven by the second voltage signal. In one of the embodiments, the first pixel unit and the second pixel unit are adjacent pixel units. In addition, the absolute value of the first voltage signal is greater than that of a preset voltage, and the absolute value of the second voltage signal is less than that of the preset voltage; or the absolute value of the first voltage signal is less than that of a preset voltage, and the absolute value of the second voltage signal is greater than that of the preset voltage. In one of the embodiments, the preset voltage is the voltage required for normal display of each pixel unit. Based on the above, the adjacent pixel units are respectively driven by voltage signals of different values. In this way the display of adjacent pixel units is mixed, so as to improve the chroma viewing angle of the display panel.

According to the embodiment of the present invention, a display module is further provided.

The display module includes a backlight board and a display device;

the display device includes a display panel and a driving module;

the display panel includes pixel units arranged in array;

the driving module is configured to: drive a first pixel unit by a first voltage signal, and drive a second pixel unit by a second voltage signal;

the first pixel unit and the second pixel unit are adjacent pixel units;

an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit;

the backlight board is configured to provide a light source for the display panel.

According to the above display module, the first pixel unit is driven by the first voltage signal, and the second pixel unit is driven by the second voltage signal. In one of the embodiments, the first pixel unit and the second pixel unit are adjacent pixel units. In addition, the absolute value of the first voltage signal is greater than that of a preset voltage, and the absolute value of the second voltage signal is less than that of the preset voltage; or the absolute value of the first voltage signal is less than that of a preset voltage, and the absolute value of the second voltage signal is greater than that of the preset voltage. In one of the embodiments, the preset voltage is the voltage required for normal display of each pixel unit. Based on the above, the adjacent pixel units are respectively driven by voltage signals of different values. In this way the display of adjacent pixel units is mixed, so as to improve the chroma viewing angle of the display panel.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

Although the application is illustrated and described herein with reference to specific embodiments, the application is not intended to be limited to the details shown. Rather, various modifications may be made in the details within the scope and range of equivalents of the claims and without departing from the application.

1. A display device, comprising:
a display panel, comprising pixel units arranged in an array; and
a driving module, configured to drive a first pixel unit by a first voltage signal, and drive a second pixel unit by a second voltage signal;
wherein the first pixel unit and the second pixel unit are adjacent pixel units;
an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit.

2. The display device of claim 1, wherein the driving module is further configured to:
drive a third pixel unit by a third voltage signal, and drive a fourth pixel unit by a fourth voltage signal; the first pixel unit, the second pixel unit, the third pixel unit, and the fourth pixel unit are pixel units arranged in sequence;
the third voltage signal is opposite in polarity to the first voltage signal; and
the fourth voltage signal is opposite in polarity to the second voltage signal.

3. The display device of claim 1, wherein the pixel unit comprises a plurality of sub-pixels;
the first voltage signal comprises a plurality of first sub-voltage signals; the second voltage signal comprises a plurality of second sub-voltage signals; the third voltage signal comprises a plurality of third sub-voltage signals; the fourth voltage signal comprises a plurality of fourth sub-voltage signals;
each of the first sub-voltage signals drives each of the sub-pixels of the first pixel unit respectively; each of the second sub-voltage signals drives each of the sub-pixels of the second pixel unit respectively; each of the third sub-voltage signals drives each of the sub-pixels of the third pixel unit respectively; each of the fourth sub-voltage signals drives each of the sub-pixels of the fourth pixel unit respectively;
the first sub-voltage signal driving the corresponding sub-pixel is opposite in polarity to the third sub-voltage signal; the second sub-voltage signal driving the corresponding sub-pixel is opposite in polarity to the fourth sub-voltage signal.

4. The display device of claim 3, wherein the driving module is further configured to:
perform a positive polarity drive to a first sub-pixel, and perform a negative polarity drive to a second sub-pixel; the first sub-pixel and the second sub-pixel are adjacent sub-pixels.

5. The display device of claim 2, wherein the pixel units arranged in sequence comprise pixel units arranged in sequence in a row direction and pixel units arranged in sequence in a column direction.

6. The display device of claim 3, wherein the pixel units arranged in sequence comprise pixel units arranged in sequence in a row direction and pixel units arranged in sequence in a column direction.

7. The display device of claim 1, wherein the adjacent pixel units comprise adjacent pixel units in a row direction.

8. The display device of claim 1, wherein the adjacent pixel units comprise adjacent pixel units in a column direction.

9. The display device of claim 4, wherein performing a positive polarity drive to the first sub-pixel is to drive the first sub-pixel by a sub-voltage signal that is higher than a common voltage.

10. The display device according to claim 5.4, wherein performing a negative polarity drive to the second sub-pixel is to drive the second sub-pixel by a sub-voltage signal that is lower than a common voltage.

11. A driving method of a display panel, wherein the display panel comprises pixel units arranged in an array, with columns formed by an arrangement of the pixel units being arranged in a sequence in a row direction, and the driving method comprises the steps of:
driving a first pixel unit by a first voltage signal, and driving a second pixel unit by a second voltage signal;
wherein the first pixel unit and the second pixel unit are adjacent pixel units;
an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit.

12. The driving method of a display panel of claim 11, further comprising the steps of:
driving a third pixel unit by a third voltage signal, and driving a fourth pixel unit by a fourth voltage signal; wherein the first pixel unit, the second pixel unit, the third pixel unit, and the fourth pixel unit are pixel units arranged in sequence;
the third voltage signal is opposite in polarity to the first voltage signal; and
the fourth voltage signal is opposite in polarity to the second voltage signal.

13. The driving method of a display panel of claim 12, wherein the pixel unit comprises a plurality of sub-pixels; the first voltage signal comprises a plurality of first sub-voltage signals; the second voltage signal comprises a plurality of second sub-voltage signals; the third voltage signal comprises a plurality of third sub-voltage signals; the fourth voltage signal comprises a plurality of fourth sub-voltage signals;
each of the first sub-voltage signals drives each of the sub-pixels of the first pixel unit respectively; each of the second sub-voltage signals drives each of the sub-pixels of the second pixel unit respectively; each of the third sub-voltage signals drives each of the sub-pixels of the third pixel unit respectively; each of the fourth sub-voltage signals drives each of the sub-pixels of the fourth pixel unit respectively;
the first sub-voltage signal driving the corresponding sub-pixel is opposite in polarity to the third sub-voltage signal; the second sub-voltage signal driving the corresponding sub-pixel is opposite in polarity to the fourth sub-voltage signal.

14. The driving method of a display panel of claim 13, further comprising the steps of:
performing a positive polarity drive to a first sub-pixel, and performing a negative polarity drive to a second sub-pixel; wherein the first sub-pixel and the second sub-pixel are adjacent sub-pixels.

15. The driving method of a display panel of claim 12, wherein the pixel units arranged in sequence comprise pixel units arranged in sequence in a row direction and pixel units arranged in sequence in a column direction.

16. The driving method of a display panel of claim 13, wherein the pixel units arranged in sequence comprise pixel units arranged in sequence in a row direction and pixel units arranged in sequence in a column direction.

17. The method of driving a display panel of claim 11, wherein the adjacent pixel units comprise adjacent pixel units in a row direction.

18. The method of driving a display panel of claim 11, wherein the adjacent pixel units comprise adjacent pixel units in a column direction.

19. The driving method of a display panel of claim 14, wherein performing a positive polarity drive to the first sub-pixel is to drive the first sub-pixel by a sub-voltage signal that is higher than a common voltage.

20. A display module, comprising a backlight board and a display device; wherein
the display device comprises a display panel and a driving module;
the display panel comprises pixel units arranged in array;
the driving module is configured to: drive a first pixel unit by a first voltage signal, and drive a second pixel unit by a second voltage signal;
the first pixel unit and the second pixel unit are adjacent pixel units;
an absolute value of the first voltage signal is greater than that of a preset voltage, and an absolute value of the second voltage signal is less than that of the preset voltage; or an absolute value of the first voltage signal is less than that of a preset voltage, and an absolute value of the second voltage signal is greater than that of the preset voltage; the preset voltage is the voltage required for normal display of each pixel unit; and
the backlight board is configured to provide a light source for the display panel.
